(19) United States
(12) Patent Application Publication
(10) Pub. No.: US 2010/0010955 A1
(43) Pub. Date: Jan. 14, 2010

(54) Molecule Fragmentation Scheme and Method for Designing New Molecules

(75) Inventor: Supreet K. Deshpande, Maharashtra (IN)

Correspondence Address: CROWELL & MORING LLP;INTELLECTUAL PROPERTY GROUP, P.O. BOX 14300, WASHINGTON, DC, 20044-4300, US

(73) Assignee: VLIFE Sciences Technologies PVT Ltd., Pune (IN)

(21) Appl. No.: 12/523,282

(22) PCT Filed: Jan. 16, 2008
(86) PCT No.: PCT/IN2008/000023

§ 371 Date: Jul. 15, 2009

(30) Foreign Application Priority Data
Jan. 18, 2007 (IN) 105/MUM/2007

(51) Int. Cl. G06N 5/02; G06F 17/30

(52) U.S. Cl. 706/47; 707/104.1; 707/E17.044

(57) ABSTRACT

Group based QSAR method (G-QSAR) is reported which uses descriptors evaluated only for the substituent groups or molecular fragments rather than whole molecule for generating QSAR. In addition, cross terms are calculated from product of descriptors at different substituent sites or fragments and used as descriptors to improve the QSAR models. This method provides QSAR models with predictive ability similar or better to conventional methods and in addition provides hints for sites or fragments of improvement in the molecules. The descriptor ranges for substituents or fragments are used to search for new groups/fragments leading to design of novel molecules with improved activity/property.

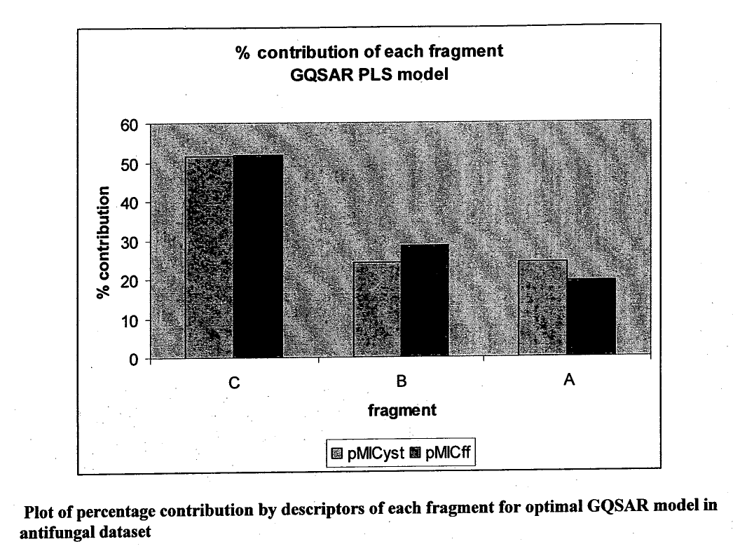

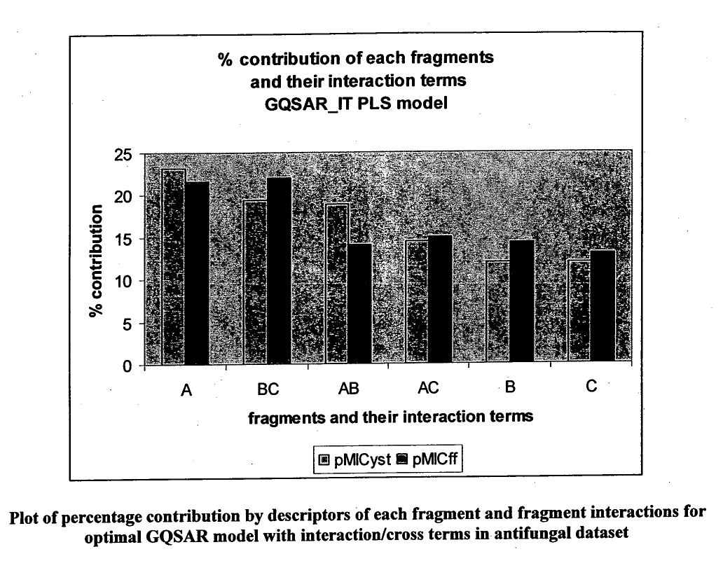

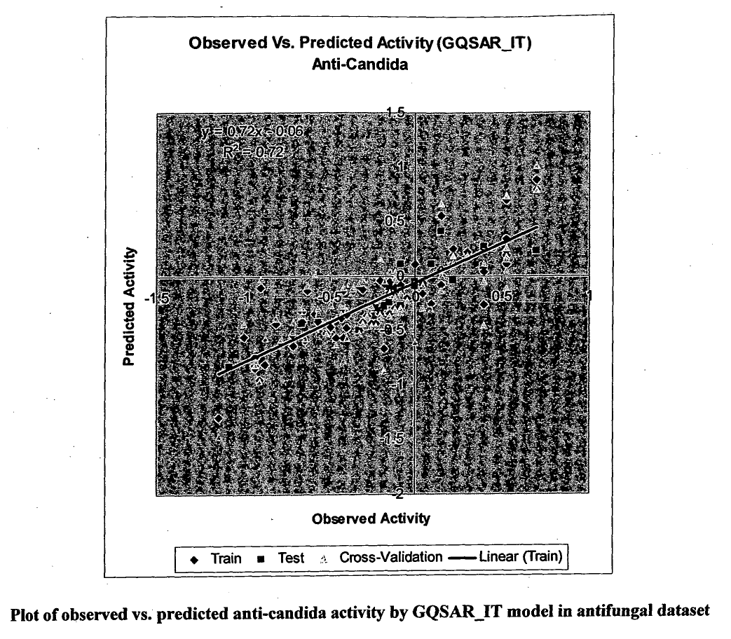

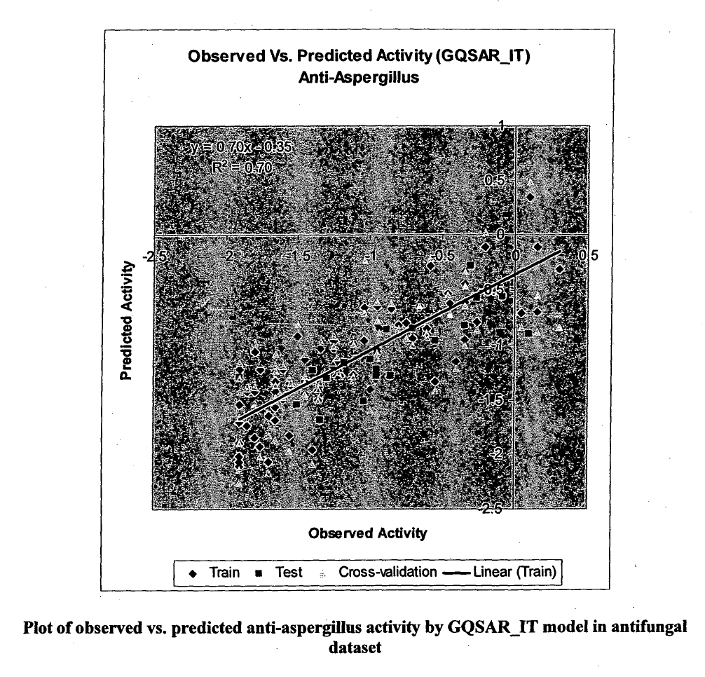

### FIELD OF INVENTION

This invention relates to designing of novel molecules using a method which allows defining and identifying the properties as well as sites of molecule governing the desired activity. This method uses chemical rules for fragmenting the molecules, calculating their properties and relating them with the activity.

### BACKGROUND

Historically in Hansch method, descriptors used for QSAR were in terms of experimentally determined group properties such as Hammett and Taft constants that are related to chemical environment and steric properties of groups (See Gasteiger, J. and Engel, T. Ed. “Chemoinformatics: A Textbook”, Wiley-VCH, Weinheim, 2003; Oprea, T. I. Ed. “Chemoinformatics in Drug Discovery” Wiley-VCH, Weinheim, 2005; Kubinyi, H. “QSAR: Hansch analysis and related approaches” VCH, Weinheim, 1993). These group constants are considered to be independent of each other and their interactions are completely ignored in this method.

After introduction of several theoretical molecular descriptors such as topological, electrotopological, etc., the current QSAR models are generated using these descriptors that represent properties of whole molecule rather than corresponding group contributions. Although these properties have played important role in identifying relationship with the activity, the exact interpretation of these conventional QSAR models has always been a challenging task. These models do not clearly specify site at which modification is required.

For this purpose, 3D-QSAR models such as CoMFA have played vital role. See Cramer, R. D.; Patterson, D. E.; Bunce, J. D. J. Am. Chem. Soc. 1988, 110, 5959-5967; see also U.S. Pat. No. 5,025,388. The 3D-QSAR descriptors are local shape fields i.e. steric and electrostatic fields calculated at the grid points generated around aligned set of molecules. As the descriptor space is very large, 3D-QSAR models are generated by using regression methods such as partial least squares (PLS) method, which can reduce the descriptor space dimensionality. The 3D-QSAR models can provide clues for designing new molecules by specifying areas along with its steric and electrostatic requirements of the molecules. However, one of the major limitations of 3D-QSAR method is their dependency on molecular alignment and choice of conformation used to generate QSAR. In addition, for non congeneric series of molecules identifying rule for alignment would be challenge.

In order to overcome the limitations of 2D/3D QSAR methods, a recent patent reports 1D QSAR method that creates 1D profile of a set of molecules having same biological activity and then identify the features that are common to all or most of the molecules. See Patent Application Pub. No.: WO2006055918.

From above discussion, it is clear that there is a requirement of QSAR method, which will be site specific (in terms of molecular fragment/group) and capture various possible interactions amongst them. In addition, unlike 3D-QSAR, this method does not require conformational analysis and alignment of the molecules to provide clues about sites and nature of interactions responsible for activity variation.

Although, above QSAR methods are used for screening of virtual combinatorial libraries, they do not provide clues for choice of substitution groups or fragments for improvement in the activity or property of new molecules to be synthesized.

The objective of present invention is to design novel molecules with desired properties by overcoming some of the problems mentioned in prior art. Another object is to develop an approach that could be applied to wide variety of problems i.e. deriving QSAR for cogeneric/non-cogeneric set of molecules and would provide ease of interpretation in terms of inverse QSAR i.e. providing direction for novel molecule design. The present invention reports a method that derives quantitative relationship of activity or property with the groups or fragments of the molecules generated on the basis of a rule derived for the dataset under consideration. The definition of chemical rules allows flexibility to focus on the specific molecular site(s) of interest for establishing QSAR and hence can provide clues for design of new molecules from various aspects of molecular structure.

The present invention also reports method of identifying new groups or fragments based on ranges of descriptors of the groups or fragments leading to design of novel molecules with desired properties.

### SUMMARY

Present invention reports an approach which deals with molecular fragment/group (derived by applying specific chemical rules) based descriptors to build QSAR model and identify important molecular site(s) and their corresponding property to aid in novel molecule design with desired molecular activity or property.

In the present study we have demonstrated use of partitioning of molecular descriptor information into the substituent group or molecular fragment based descriptors. In addition, we have shown to utilize the cross terms (i.e product of group based descriptors) in the improvement of conventional QSAR models as well as G-QSAR models.

The methodology was applied on two datasets of Cox-2 inhibitors (congeneric series) and anti-fungal molecules (non-congeneric) by evaluating simple 2D descriptors to generate QSAR, G-QSAR and G-QSAR_IT models using multiple regression and partial least squares regression methods.

Herein we have demonstrated that applying simple chemical rules to divide chemical structure (to obtain corresponding fragment descriptors for G-QSAR) could be useful to get much better understanding of molecular mechanism of biological activity variation as compared to conventional QSAR. In addition, it is shown that the use of cross terms (i.e product of fragment based descriptors) could be useful in the improvement of G-QSAR models. The proposed G-QSAR methodology allows ease of interpretation unlike any conventional QSAR method which could only suggest important descriptor but does not reflect the site where it has to be optimized for design of new molecules.

### DETAILED DESCRIPTION OF INVENTION

The present invention allows deriving quantitative relationship between activity and descriptors calculated for, various molecular groups or fragments of interest. Thus the fragmentation of the molecules forms a pre-requisite step in order to perform QSAR. Herein after, the method reported herein that allows generation of QSAR model based on descriptors of groups or fragments is designated as G-QSAR method.

The fragmentation of a molecule becomes simple while working with a set of congeneric molecules, i.e. simply number of sites at which the substituents are varying forms that many different fragments for a given molecule. Following is example of such case:

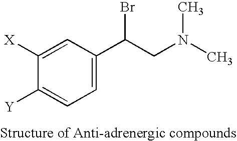

The X and Y are the substitution sites of a congeneric series of antiadrenergic active meta-, para-, and meta,para-disubstituted N,N-Dimethyl-2-bromophenethylamines. For QSAR of this set, the molecules are divided into two fragments composed of various substitutions at two sites X and Y.

In case of working with a set of non-congeneric set of molecules i.e. having chemically diverse structures or different templates in the molecule, it requires breaking up of a set of molecules with a predefined set of chemical rules, in which the molecules are considered as composed of different fragments as represented below with a simple example with 3 fragments:

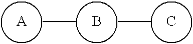

In order to consider the environment of the neighboring fragment(s) the attachment point atoms are included in the fragments. This will differentiate fragment B (w.r.t. to its environment) which will include attachment atom of A and C as compared to fragment A and C which will have only the attachment atom from B from its corresponding attachment point. For non congeneric series, the fragments may be derived from fragmentation of specific bonds, bonds on the ring fusion, regions of molecules that can be separated from common structural feature such as atom, bond and ring, or any pharmacophoric feature such as hydrogen bond donor, acceptor, charge, hydrophobe, and other features.

Once the molecular fragments are prepared, the next step in the present invention is to calculate various 2D/3D descriptors (same as whole molecular descriptor) for those fragments like established 2D descriptors chi indices, valence based chi indices, electro-topological indices, HBA, HBD, rotatable bonds and/or other 3D alignment independent descriptors dipole moment, radius of gyration, group volume, group polar surface area and similar descriptors.

In addition, the present invention also utilizes the terms corresponding to interactions between various fragments by calculating interaction/cross terms using a mathematical operators like product. As an example, if two descriptors (D1 and D2) are calculated for the two fragments A and B, following descriptors will be generated:

### D1A, D1B, D2A, D2B, D1A*D1B, D1A*D2B, D1B*D2A, D2A*D2B, D1A*D2A, D1B*D2B

Where, D1A, D1B are calculated descriptor D1 for the two fragments A and B and D2A, D2B are calculated descriptor D2 for the two fragments A and B.

The third step in the present invention is to build a quantitative model. Since a large pool of descriptors is now available for building a quantitative model and not all of the descriptors are important for the activity, one needs a method to pick optimal subset of descriptors that explains variation in the activity. For this purpose various variable selection methods are available and can be coupled with variety of statistical methods available for building quantitative model.

Few variable selection methods and quantitative model building methods used in present invention are enumerated below:

### Variable Selection Methods:

Stepwise forward, stepwise forward-backward, stepwise backward, simulated annealing method, genetic algorithm and others

### Statistical Model Building Methods:

Multiple regression, principal component regression, partial least squares regression, continuum regression, k-nearest neighbor, neural networks and others
In principle any variable selection method can be coupled with any statistical method of choice for building quantitative model.

The present invention also describes use of quantitative models generated.

### Example 1

### 1.1 Cox-2 Inhibitor Dataset

This method was tested on the series of Cox-2 inhibitors (NSAID) as reported in the literature see Desiraju, G. R.; Gopalakrishnan B.; Jetti, R. K. R.; Raveendra, D.; Sarma, J. A. R. P.; Subramanya, H. S., Molecules 2000, 5, 945-955. Initially we derived conventional QSAR model from molecular descriptors and compared it with the corresponding group based QSAR model. Based on common fragment of 1,5-diphenylpyrazole several group based descriptors were evaluated. We have used 25 molecules as training set and 5 molecules as test set as described in the original paper of Desiraju et al.

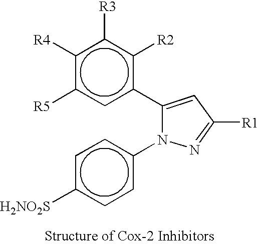

This is an example of application of proposed methodology on a set of congeneric series molecules i.e. having a common template and variation of chemical substituents at various substitution sites. Since the same descriptors are calculated for various groups at different sites the following nomenclature is used for naming a descriptor at a particular position for e.g. R1_Mol. Wt. represents the molecular weight of the group present at R1 substitution site. Following formula was used for calculation of interaction/cross terms of the various group descriptors at different substituent sites e.g.:

R3_{—}s log p*R4_Mol. Wt.=R3s log p×R4_Mol. Wt.

Where, R3_s log p corresponds to value of s log P of the group at R3 substitution site and R4_Mol. Wt. is the value of molecular weight of the group at R4 substitution site.

### 1.2 QSAR Model

To build QSAR model PLS regression method was applied on selected set of 8 descriptors which resulted in a statistically significant model with 6 PLS components as reported in table 1.

### 1.3 Group/Fragment Based QSAR (G-QSAR) Model

The stepwise multiple linear regression analysis resulted in a significant G-QSAR model with 5, descriptors. The descriptors and the statistical parameters of the model are reported in table 1.

1.4 Group/Fragment Based QSAR with Interaction Terms (G-QSAR_IT) Model

PLS regression method applied on a selected set of 12 descriptors which includes both group based and interaction term descriptors led to a statistically significant QSAR model with 4 PLS components as reported in table 1.

The conventional QSAR model (table 1) is statistically significant and indicates the significance of basic molecular properties such as hydrogen bond acceptor counts, hydrogen bond donor counts, log partition coefficient (s log P) etc., however it does not show the site where variation is required leading to difficulty in interpretation. In order to get better insights of group descriptors important in explaining variation of activity G-QSAR and G-QSAR_IT models were developed.

It can be seen from the table 1 that substitution sites R2, R3 and R4 were found to be playing major role in G-QSAR and G-QSAR_IT models and this in line with the amount of variation in chemical substitution at the various substitution sites. The R1 and R5 site descriptors do not appear in models since the variation of groups at those sites are not significant.

### Example 2

### 2.1 Anti-Fungal Dataset

The biological activity data of two series of i) Heterocyclecarboxamide derivatives of 3-amino-2-aryl-1-azolyl-2-butanol and ii) 3-substituted-4(3H)-quinazolinones reported as anti-fungal molecules were collected from the research papers see Bartroli, J.; Turmo, E.; Forn, J. J. Med. Chem. 1998, 41, 1855-1868 & 1869-1882. In order to consider further structural variation in the molecules in the present study, other standard anti-fungal molecules i.e. itraconazole, voriconazole etc. were included in the dataset.

The biological activities were expressed in terms of geometric mean of MIC values (μg/ml) against 10 yeasts (i.e. anti-candida) and against 6 filamentous fungi (i.e. anti-aspergillus). For QSAR analysis the activity was converted into negative logarithm of MIC values (pMIC). In the present study two activities i.e. pMICyst and pMICff were used which represents anti-candida and anti-aspergillus activities respectively.

The main objective of the present study was to develop a single QSAR model for both the activities so that it can provide an insight into various structural features influencing both activities simultaneously which could finally be used for optimization and design of dual active molecule.

### 2.2 Rules for Molecular Fragmentation and Descriptor Calculation

The present case of anti-fungal molecules is an example of non-congeneric series of molecules, in which the molecules are considered as composed of different fragments as follows:

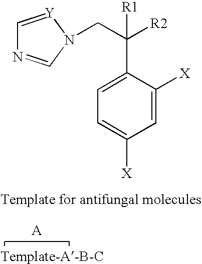

Fragment A: It is defined as part of molecule traced from the template either from path R1 or R2 until a ring structure is found. If the ring found in R1/R2 path is fused, first ring is considered as part of A and the second ring forms the part of fragment B.

Fragment B: It is formed by a single ring structure after fragment A.

Fragment C: Finally the remaining portion of the molecule that follows fragment B is considered as fragment C.

In order to consider the environment of the neighboring fragment(s) the attachment point atoms are included in the fragments.

For QSAR analysis various 2D descriptors (a total of 360) like element counts, molecular weight, molecular refractivity, log P, topological index, electro-topological index, Baumann alignment independent topological descriptors etc. were calculated using VLifeMDS software see VLifeMDS: Molecular Design Suite developed by VLife Sciences Technologies Pvt. Ltd., Pune, India 2006.

Each molecule was divided into 3 fragments as described above and the descriptors of the molecules (same as in QSAR) were calculated for various fragments of the molecule. Following are few representative molecules and their corresponding fragments considered in the present study.

| Molecule | Fragment A | Fragment B | Fragment C |
|---|---|---|---|
| 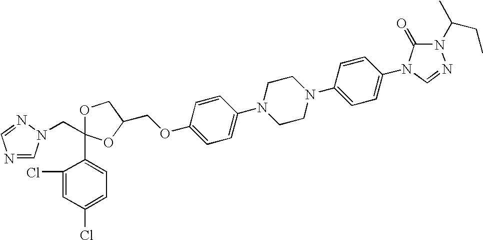 | 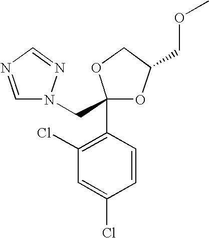 | 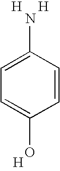 | 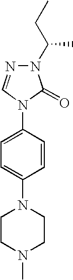 |
| 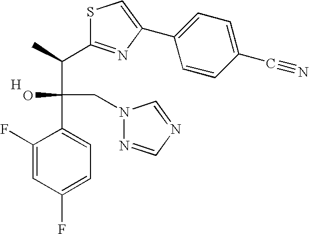 | 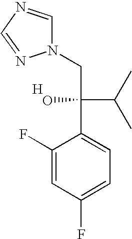 | 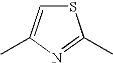 | 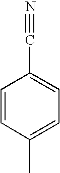 |
| 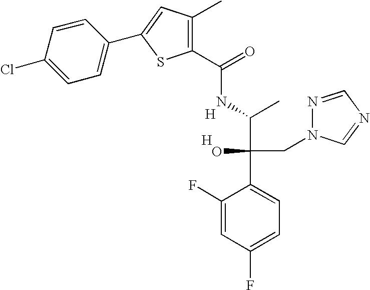 | 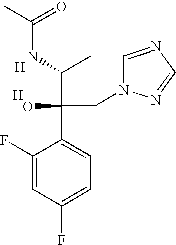 | 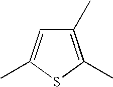 | 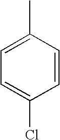 |
| 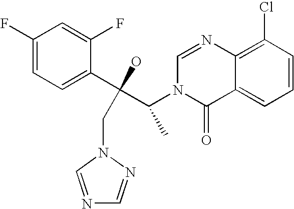 | 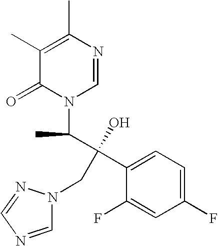 | 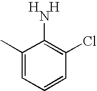 | 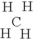 |

The preprocessing of the calculated descriptors led in total 729 descriptors. Since the same descriptors are calculated for the different fragments of the molecules, the following nomenclature is used for naming a descriptor for a particular fragment e.g. A_Mol. Wt represents the molecular weight of the fragment A.

Following formula was used for calculation of interaction/cross terms of the various fragments e.g.:

B_{—}s log p*C Mol. Wt.=B_{—}s log p×C_Mol. Wt.

Where, B_s log p corresponds to value of s log P of the fragment B and
C_Mol. Wt is value of molecular weight of fragment C.

In the present study the interaction/cross terms were calculated only for the descriptors of the fragments which are found to be significant in GQSAR analysis and thus it resulted in 240 descriptors after removing the invariable descriptors. To analyze this information and building models, various regression methods i.e. multiple regression, PLS regression and variable selection methods i.e. stepwise forward-backward and simulated annealing were used.

### 2.3 QSAR Model

For model validation at first the dataset was divided in a training set of 81 molecules and test set of 20 molecules. PLS regression applied on selected 22 descriptors (by extracting 13 PLS components) resulted in statistically significant model with respect to both the activities from 22 selected descriptors, the model parameters are reported in table 2.

### 2.4 Group Based QSAR (G-QSAR) Model

The simulated annealing variable selection coupled with partial least squares regression analysis resulted in a significant G-QSAR model with 12 PLS components extracted from a selected subset of 23 descriptors. The descriptors and the statistical parameters of the model are reported in table 2. An advantage of GQSAR method is that it provides information about the contribution (%) of each fragment in the model which is shown in graph 1.

2.5 Group Based QSAR with Interaction Terms (G-QSAR_IT) Model

The simulated annealing variable selection coupled with partial least squares regression analysis was applied on a selected set of 240 descriptors which includes both group based and interaction term descriptors. This analysis resulted in a statistically significant G-QSAR model with an optimal subset of 25 descriptors (7 PLS components) as reported in table 2. The graphs 2 show the contribution (%) of each fragment and their interactions in the PLS model.

The resulting GQSAR_IT model is a better model with optimal statistical parameters as compared with QSAR and GQSAR model. The graphs 3 and 4 shows a plot of the observed vs. predicted for both anti-candida and anti-aspergillus activities by this model.

The above study resulted in better QSAR, G-QSAR and G-QSAR_IT models using simple 2D descriptors. It can be seen from the table 2 that both the G-QSAR and G-QSAR_IT models are comparable/better than the conventional QSAR method.

The conventional QSAR model (table 2) indicates the significance of basic molecular properties such as rotatable bond counts, log partition coefficient (s log P), polar surface area (PSA) etc. It is noticed that count of oxygen atoms (which indicates importance of hydrogen bonding) in a molecule (OxygenCounts) is maximally influencing (˜12%) and is directly proportional to anti-aspergillus activity while flexibility of a molecule (RotatableBondCount) is found to be of major importance (˜14%) and is inversely proportional to anti-candida activity, however it does not show the site where variation is required leading to difficulty in interpretation. In order to get better insights of fragment descriptors important in explaining variation of activity G-QSAR and G-QSAR_IT models were developed.

It can be seen from descriptors in G-QSAR model (graph 1) that chemical variation in fragment C plays major role (˜50%) in determining both anti-fungal activities. In addition, it can noticed that fragment A and B contribute equally (˜25%) to anti-candida activity whilst fragment B (30%) influence anti-aspergillus activity as compared to fragment A (˜20%).

The GQSAR_IT analysis reveals that the fragment A and interaction of fragment B and C i.e. BC mainly influences variation in both antifungal activities. It can also be noticed that AB interaction is more important than AC interaction in governing anti-candida activity whilst AB and AC interactions influences almost equally to anti-aspergillus activity.

This study has allowed comparison of conventional QSAR method with proposed GQSAR methodology. It can be noticed that though not all the descriptors in QSAR and GQSAR models are same but few descriptors are common, which aid to the confidence in statistical model developed using different approaches. In addition as an advantage of GQSAR it also indicates the fragment from which a descriptor is contributing to the model unlike QSAR. This combination of methods allows a better interpretation of the models in terms of the contribution of each molecular fragment and/or their interactions.

TABLE 1
Statistical parameters and descriptors obtained for QSAR,
G-QSAR and G-QSAR_IT models for Cox-2 inhibitors

| | QSAR | G-QSAR | G-QSAR_IT |
|---|---|---|---|
| components | 6 | — | 4 |
| n | 25 | 25 | 25 |
| variables | 8 | 5 | 12 |
| r² | 0.932 | 0.926 | 0.931 |
| q² | 0.745 | 0.866 | 0.855 |
| pred_r² | 0.864 | 0.809 | 0.898 |
| r²_SE | 0.361 | 0.366 | 0.344 |
| q²_SE | 0.698 | 0.492 | 0.5 |
| Zscore_r² | 4.641 | 7.279 | 5.371 |
| Zscore_q² | 3.477 | 1.817 | 4.018 |
| best_ran_r² | 0.335 | 0.229 | 0.441 |
| best_ran_q² | −0.768 | −1.196 | −1.284 |
| alpha_r² | 0.0001 | 0.0000 | 0.0000 |
| alpha_q² | 0.001 | 0.05 | 0.0002 |
| F-test | 41.118 | 47.551 | 67.464 |
| Descriptor_1 | H-AcceptorCount | R2_SsCH3E-index | R2_Mol. Wt. |
| Descriptor_2 | H-DonorCount | R3_RotatableBondCount | R2_SsCH3E-index |
| Descriptor_3 | slogp | R4_chi2 | R3_smr |
| Descriptor_4 | chiV4pathCluster | R4_OxygensCount | R4_chi2 |
| Descriptor_5 | CarbonsCount | R4_SsCH3E-index | R4_OxygensCount |
| Descriptor_6 | NitrogensCount | | R4_SsCH3E-index |
| Descriptor_7 | FluorinesCount | | 0PathCount*XlogP |
| Descriptor_8 | T_2_T_4 | | R3_XlogP*R4_smr |
| Descriptor_9 | | | R3_slogp*R4_Mol. Wt. |
| Descriptor_10 | | | R3_HydrogensCount*R4_k1alpha |
| Descriptor_11 | | | R4_polarizabilityAHC*R4_chi0 |
| Descriptor_12 | | | R4_T_T_T_0*R5_smr |

TABLE 2
Statistical parameters and descriptors obtained for QSAR,
G-QSAR and G-QSAR_IT models for anti-fungal dataset

| | QSAR | | G-QSAR | | G-QSAR_IT | |
|---|---|---|---|---|---|---|
| components | 13 | | 12 | | 7 | |
| n_(train/test) | 81/20 | | 81/20 | | 81/20 | |
| variables | 22 | | 23 | | 25 | |
| | pMICyst | pMICff | pMICyst | pMICff | pMICyst | pMICff |
| r² | 0.68 | 0.67 | 0.71 | 0.69 | 0.72 | 0.70 |
| q² | 0.42 | 0.49 | 0.39 | 0.39 | 0.49 | 0.48 |
| pred_r² | 0.61 | 0.55 | 0.62 | 0.60 | 0.72 | 0.57 |
| r²_SE | 0.27 | 0.37 | 0.26 | 0.35 | 0.24 | 0.34 |
| q²_SE | 0.37 | 0.46 | 0.37 | 0.50 | 0.33 | 0.45 |
| Zscore_r² | 4.66 | 7.16 | 7.09 | 7.58 | 5.48 | 4.56 |
| Zscore_q² | 3.70 | 5.41 | 7.92 | 5.06 | 4.89 | 4.86 |
| best_ran_r² | 0.23 | 0.27 | 0.26 | 0.26 | 0.28 | 0.27 |
| best_ran_q² | −0.62 | −0.47 | −0.54 | −0.47 | −0.56 | −0.50 |
| alpha_r² | <0.0001 | <0.0001 | <0.0001 | <0.0001 | <0.0001 | <0.0001 |
| alpha_q² | <0.0001 | <0.0001 | <0.0001 | <0.0001 | <0.0001 | <0.0001 |
| F-test | | | | | | |

| | | | |
|---|---|---|---|
| Descriptor_1 | Mol.Wt. | A_SsssCHE-index | A_SsssCHE-index |
| Descriptor_2 | RotBondCount | A_T_N_F_6 | B_T_C_S_3 |
| Descriptor_3 | Slogp | A_SlogP | B_H-DonCount |
| Descriptor_4 | OxygensCount | B_T_N_O_1 | C_T_T_Cl_5 |
| Descriptor_5 | SsssCHE-index | B_T_C_N_5 | C_T_2_C_1 |
| Descriptor_6 | StsCE-index | B_T_T_N_5 | C_PSAExclPandS |
| Descriptor_7 | SaasN(Noxide)E-index | B_T_T_O_1 | A_SsssCHE-index*C_Mol.Wt. |
| Descriptor_8 | SsCIE-index | B_T_C_S_3 | A_T_N_F_6*A_SlogP |
| Descriptor_9 | PSAInclPandS | B_T_C_Cl_3 | A_T_N_F_6*B_T_T_N_5 |
| Descriptor_10 | T_2_O_5 | B_T_T_S_4 | A_T_N_F_6*B_T_C_N_1 |
| Descriptor_11 | T_2_F_5 | B_H-DonorCount | A_SlogP*B_T_T_O_1 |
| Descriptor_12 | T_T_O_5 | B_SdsNE-index | A_SlogP*B_T_C_Cl_3 |
| Descriptor_13 | T_C_S_3 | B_T_C_N_1 | A_SlogP*C_SsCIE-index |
| Descriptor_14 | T_C_Cl_4 | B_PSAExclPandS | B_T_C_N_5*C_T_2_C_1 |
| Descriptor_15 | T_N_N_1 | C_T_O_F_2 | B_T_T_N_5*B_T_C_Cl_3 |
| Descriptor_16 | T_N_N_5 | C_SdssCcount | B_T_T_O_1*C_T_T_Cl_5 |
| Descriptor_17 | T_N_O_1 | C_T_T_Cl_5 | B_T_C_S_3*B_T_C_N_1 |
| Descriptor_18 | T_N_O_2 | C_SsCIE-index | B_T_C_S_3*C_T_O_O_2 |
| Descriptor_19 | T_N_O_4 | C_H-DonorCount | B_T_C_Cl_3*C_SsCIE-index |
| Descriptor_20 | T_N_S_5 | C_StsCE-index | B_T_T_S_4*C_T_2_C_1 |
| Descriptor_21 | T_O_O_2 | C_T_2_C_3 | B_H-DonCount*C_PSAExclPandS |
| Descriptor_22 | T_F_S_4 | C_PSAExclPandS | B_SdsNE-index*B_T_C_N_1 |
| Descriptor_23 | | C_Mol.Wt. | B_T_C_N_1*C_SdssCcount |
| Descriptor_24 | | | C_T_O_F_2*C_Mol.Wt. |
| Descriptor_25 | | | C_SdssCcoun*C_StsCE-index |

1. A method to design novel molecules comprising: generation of molecular fragments of given set of compounds based on defined specific rules for the set
a. evaluating properties of said fragments
b. deriving relationship of said fragment properties with molecular activity or property leading to identification of important properties of fragments
c. identifying important property ranges of fragments
d. searching the fragments in the fragment database satisfying the said ranges of important properties
e. combining the searched fragments to create novel molecules

2. The method according to claim 1 wherein for the said given set of compounds, the activities or properties are experimentally obtained from the same assay method or same experimental procedure.

3. The method according to claim 1 wherein the said fragments are derived based on common rules for the given set of compounds, where for the congeneric series of molecules, such fragments are the substituents at the substitution sites of the common template and for non congeneric series, the fragments may be derived from fragmentation of specific bonds, bonds on the ring fusion, regions of molecules that can be separated from common structural feature such as atom, bond and ring, or any pharmacophoric feature such as hydrogen bond donor, acceptor, charged group or atom, hydrophobic group, etc.

4. The method according to claim 1 wherein the said fragment properties are those obtained from various two dimensional and three dimensional molecular descriptors like: molecular weight, volume, number of hydrogen bond donors, number of hydrogen bond acceptors, number of rotatable bonds, log P values from various methods, molecular connectivity indices like Chi and ChiV, Hosoya indices, Weiner indices, topological indices, electrotopological indices, path count, chain count, kappa indices, polar surface area, electrostatic descriptors over van der Waals surface like negative potential surface area, positive potential surface area, mean potential, maximum and minimum potential, alignment independent descriptors, and other molecular descriptors.

5. The method according to claim 1 wherein the said fragment properties also include cross terms or interaction terms obtained from any mathematical operator or function such as scalar product of descriptor properties.

6. The method according to claim 1 wherein the said relationship of activity/property with the fragment based descriptors is derived using different combinations of variable selection methods and statistical methods.

7. The method according to claim 6 wherein the said variable selection method is systematic selection such as stepwise forward selection, stepwise backward selection, stepwise forward-backward selection and stochastic selection methods such as simulated annealing, genetic algorithm.

8. The method according to claim 6 wherein the said statistical method is any of linear methods such as multiple regression method, principal component regression, partial least squares regression or any of the non-linear methods such as k-nearest neighbor method, neural networks.

9. The method according to claim 1 wherein the said ranges of fragment properties are derived from the ranges of properties or descriptors that form relationship with the said activity or property for active molecules or molecules with desired property ranges in the dataset.

10. The method according to claim 1 wherein the said novel fragments are obtained by search of fragments in database that satisfy derived ranges for all the fragment descriptors that form relationship with activity or property.

11. The method according to claim 1 wherein the said novel molecules are generated by combining derived fragments which satisfy the said property ranges of the descriptors of all fragments.

12. The method to design novel molecules using a computer program as substantially described herein particularly with reference to the description and examples.

13. A computer program for designing novel molecules comprising of
a. generation of molecular fragments of given set of compounds based on defined specific rules for the set
b. evaluating properties of said fragments
c. deriving relationship of said fragment properties with molecular activity or property leading to identification of important properties of fragments
d. identifying important property ranges of fragments
e. searching the fragments in the fragment database satisfying the said ranges of important properties
f. combining the searched fragments to create novel molecules.

14. The method according to claim 4 wherein the said fragment properties also include cross terms or interaction terms obtained from any mathematical operator or function such as scalar product of descriptor properties.

15. The method according to claim 9 wherein the said novel fragments are obtained by search of fragments in database that satisfy derived ranges for all the fragment descriptors that form relationship with activity or property.

16. The method according to claim 10 wherein the said novel molecules are generated by combining derived fragments which satisfy the said property ranges of the descriptors of all fragments.
